(19) United States
(12) Patent Application Publication
(10) Pub. No.: US 2003/0071505 A1
(43) Pub. Date: Apr. 17, 2003

(54) Seat for a tailgate

(76) Inventor: Robert E. Ferrell JR., Kill Devil Hills, NC (US)

Correspondence Address: Robert E. Ferrell, Jr., 308 Live Oak Ct, Kill Devil Hills, NC, 27948, US

(21) Appl. No.: 09/978,219

(22) Filed: Oct. 16, 2001

(51) Int. Cl. B60N 2/00

(52) U.S. Cl. 297/352

(57) ABSTRACT

The invention is a seat for a tailgate or door on an automobile. The invention includes a tailgate for a pickup and a retrofit insert for existing tailgates. The ergonomically shaped seat allows one to sit on a tailgate during tailgating parties or other times when the tailgate is lowered. The seat may also include an accessory attachment device.

### BACKGROUND OF THE INVENTION

Throughout this application, the invention is described as being used on a pickup truck. It should be understood that the term pickup truck is defined to include all automobiles or motor vehicles. Further, the term tailgate is defined to include any door on an automobile that opens in a downward manner.

In America tailgating at sporting events such as college football games or NASCAR® races is a tradition that has been passed down through several generations. Typically, attendees of sporting events show up at the field or track several hours early and conduct informal tailgating parties. Many of the attendees to these sporting events drive pickup trucks or sports utility vehicles. When tailgating, the driver of the pickup may lower the tailgate and rest thereupon in a seated manner.

Typically, a tailgate of a pickup has corrugations or other protrusions that are not ergonomically sound for sitting upon. Thus, a tailgater cannot properly sit on a tailgate of a pickup for extended periods without experiencing soreness in his back or posterior region of his body.

### BRIEF SUMMARY OF THE INVENTION

The invention recognizes and realizes the need for an ergonomically designed seat for a tailgate or door. Either the seat may be manufactured as a tailgate/door or an insert for a tailgate that may be retrofitted onto the tailgate after the pickup has been sold by the manufacturer.

It is an object of the invention to provide a comfortable seat for a tailgate. The seat may be either detachable or it may be manufactured as part of the tailgate.

### BRIEF DESCRIPTION OF THE DRAWINGS

FIG. 1 is a perspective view of a conventional pickup truck.

FIG. 2 is an overhead view of a seat for a tailgate.

FIG. 3 is an elevation front view of the seat for the tailgate.

FIG. 4 is a side view of a seat for a tailgate on a conventional pickup.

FIG. 5 is a cross sectional side view of the molded seat.

FIG. 6 is a view of an adjustable connector and base portion for receiving the adjustable connector.

FIG. 7 is a perspective view of an offset table.

FIG. 8 is a perspective view of a rod holder accessory.

### DETAILED DESCRIPTION OF THE INVENTION

The following is the preferred embodiment or best mode for carrying out the invention. It should be noted that this invention is not limited by the discussion of the preferred embodiment, and reasonable alternatives may be substituted for individual elements of the invention without deviating from the scope of the invention.

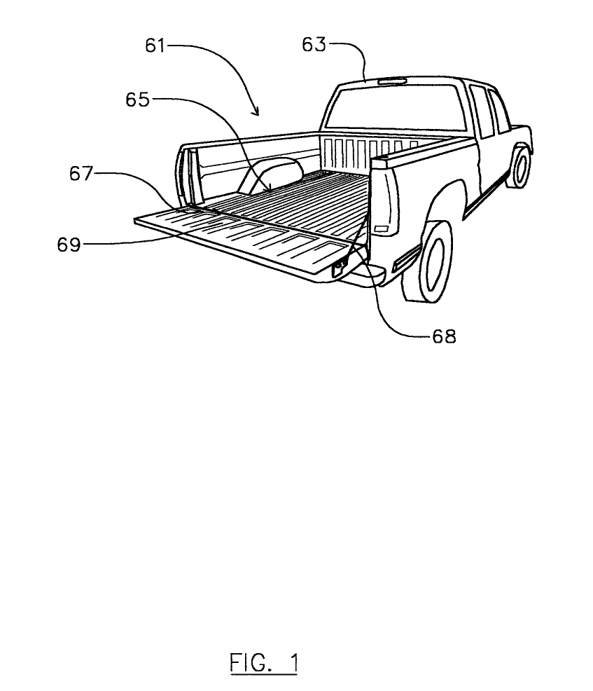

FIG. 1 illustrates a conventional pickup truck 61 having a cab 63 and a bed 65. A tailgate 67 is pivotally attached to the rear of bed 65 for opening and closing the bed 65. As shown in FIG. 1, the tailgate 67 includes a plurality of separated, inverted U-shaped longitudinal corrugations 69. A metal hinge or cable 68 supports tailgate 67.

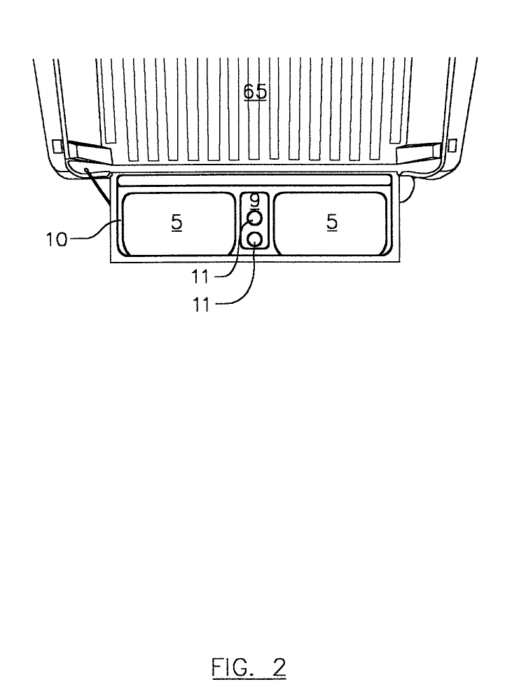

FIG. 2 is an overhead view of a detachable tailgate seat 1 for a conventional pickup 61. The seat includes two molded seats 5 that are ergonomically designed into a base 10. Seats 5 may include a drain comprised of a hole. Located between seat 5 is an armrest 9. It should be noted that the detachable tailgate seat might comprise a single molded seat. Further it may include a plurality of armrests.

In FIG. 2, cup holders 11 are indentations in the armrest 9. Cup holders 11 include a drain comprising a hole for draining liquids from the cup holders 11. The diameter of each cup holder 11 is at least the size of a beverage can such as a soda, roughly 3.5 inches in diameter. The cup holders 11 may include a built-in insulated portion commonly known as a beverage “hugger.” A backrest 3 is hingably interconnected with base 10. Plastic, fiberglass or other lightweight, high strength, molded materials may be used as the materials for the detachable tailgate seat.

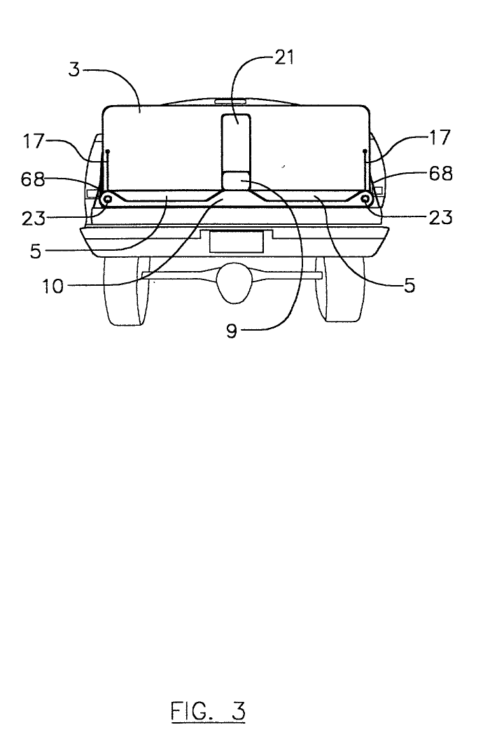

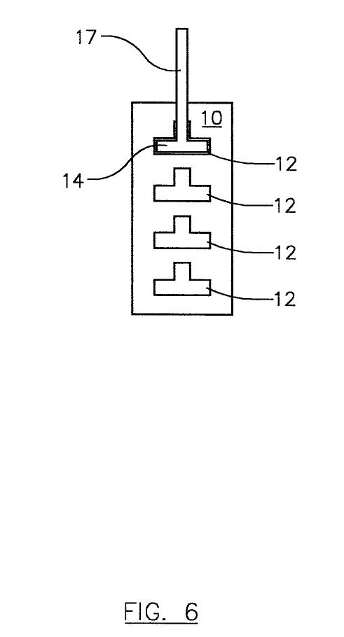

FIG. 3 shows a backrest 3 having a recessed complementary indentation 21 for receiving armrest 9 when the seat is folded. The backrest 3 has support cable 17 connecting base 10 with backrest 3. The support cable 17 is adjustable as shown in FIG. 6.

Base 10 includes female indentations 23 for accepting threaded male connectors of an accessory. Other such threaded indentations 23 for adding additional accessories may be included on base 10 or backrest 3. Two molded seats 5 are included in base 10.

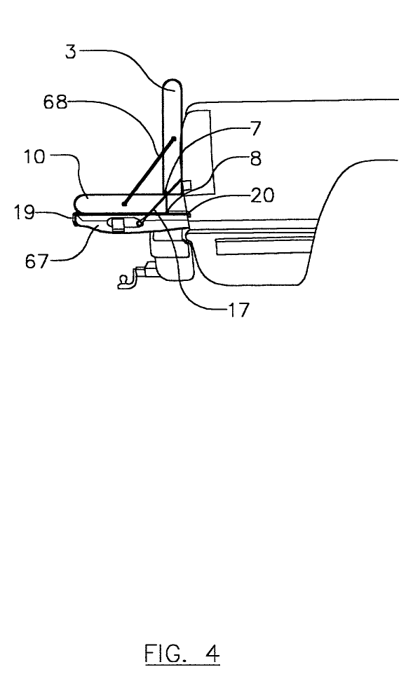

FIG. 4 shows a side view of the hinge 7 that connects backrest 3 with base 10. The hinge(s) may be constructed of stainless steel, brass or other durable metal materials. Screws or other fastening devices may be used to attach the hinge(s) to the backrest and the base or seat. The hinge 7 may also be comprised of a plastic bridge that connects the backrest to the base or seat.

Attachment means 19 is connected to an end of base 10. Attachment means 20 is connected to an end of base 10. In the preferred embodiment, attachment means 20 is hinged by hinge 8. Attachment means 19 may be a curved lip that curls over an edge of the tailgate as shown in FIG. 4. Attachment means 20 may be a hinged piece of plastic, metal or other material assuming a 90° angle for cooperating with an end of the tailgate opposite the end cooperating with attachment means 19.

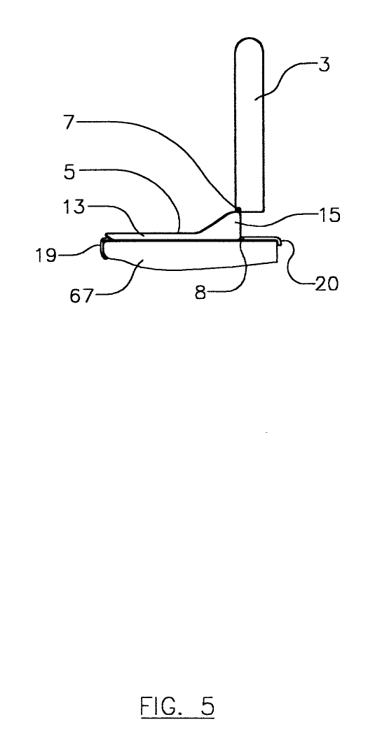

FIG. 5 is a cross section view of a molded seat 5 and tailgate 67. The edge 15 of the molded seat nearest the hinge 7 is thicker than an opposite edge 13.

FIG. 6 is a close up view of the adjustable connector and base portion for receiving an end of cable 17. Base 10 is comprised of t-shaped holes 12 for receiving t-shaped connector 14. It should be noted that the t-shape might be substituted for any other shape that may be accommodated by a molded hole.

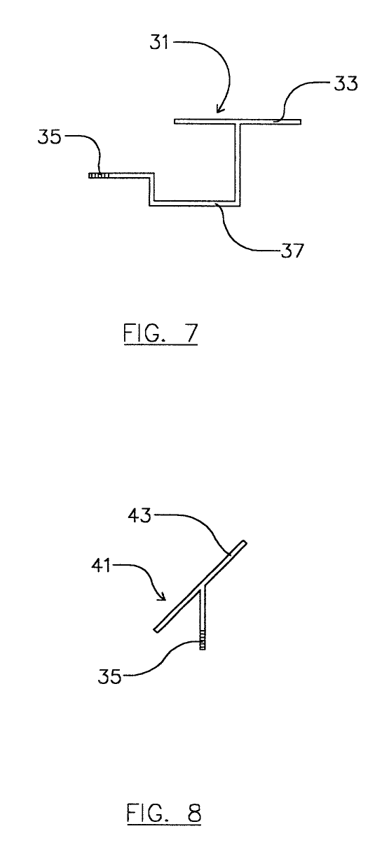

FIG. 7 is a view of an offset table 31 comprising a flat surface 33 with a male threaded connector 35 that attaches to the threaded female indentations shown in Figure 3. An offset arm 37 projects table 31 away from the detachable tailgate seat 1. It should be noted that table 31 may be manufactured with threaded connector 35 and without offset arm 37.

FIG. 8 is a view of a rod holder 41 for securing fishing rods. Rod holder 41 comprises a hollow piece 43 for accommodating a fishing pole. The hollow piece 43 is typically 1.5″ in diameter. A threaded connector 35 extends from a lower portion of hollow piece 43.

It is to be understood that the invention is not limited to the exact construction illustrated and described above. Various changes and modifications may be made without departing from the spirit and the scope of the invention as defined in the following claims.

I claim:

1. A detachable tailgate seat comprising:
a backrest;
at least one molded seat;
a hinge connecting said backrest with said molded seat; and
at least one armrest located next to the molded seat.

2. The detachable tailgate seat of claim 1, further comprising: a cup holder.

3. The detachable tailgate seat of claim 2 wherein said molded seat is thinner in cross-section on an end opposite an end located nearest said hinge.

4. The detachable tailgate seat of claim 1, further comprising a support cable.

5. The detachable tailgate seat of claim 1, further comprising a pair of molded seats.

6. The detachable tailgate seat of claim 5 wherein said pair of molded seats are thinner in cross-section on ends opposite other ends located nearest the hinge.

7. The detachable tailgate seat of claim 6 further comprising a set of hinges for connecting the backrest with the molded seat.

8. The detachable tailgate seat of claim 1 further comprising attachment means located on said backrest for attaching the detachable tailgate seat to the tailgate of an automobile.

9. The detachable tailgate seat of claim 1 further comprising attachment means located on the seat near the hinge for attaching the detachable tailgate seat to a tailgate of an automobile.

10. The detachable tailgate seat of claim 1 further comprising attachment means located on the seat near an end opposite the hinge for attaching the detachable tailgate seat to a tailgate of an automobile.

11. The detachable tailgate seat of claim 1 further comprising a complementary recess in the backrest for receiving the armrest when the tailgate seat is folded.

12. The detachable tailgate seat of claim 1 further comprising at least a threaded female indentation for receiving a threaded male connector.

13. The detachable tailgate seat of claim 12 further comprising an accessory having a threaded male connector.

14. The detachable tailgate seat of claim 1 further comprising a plurality of armrests.

15. The detachable tailgate seat of claim 1 further comprising a plurality of cup holders.

16. A tailgate comprising:
a backrest;
at least one molded seat;
a hinge connecting said backrest with the molded seat; and
at least one armrest located next to the molded seat.

17. The tailgate of claim 16 further comprising a cup holder.

18. The tailgate of claim 16 wherein said molded seat is thinner in cross section on an end opposite and end located near the hinge.

19. The tailgate of claim 16 further comprising a support cable connecting said backrest with said molded seat.

20. The tailgate of claim 16 further comprising at least a threaded female indention for receiving a threaded male connector.
